(19) United States
(12) Patent Application Publication
(10) Pub. No.: US 2007/0205199 A1
(43) Pub. Date: Sep. 6, 2007

(54) SHOT GLASS AND METHOD

(76) Inventor: Randy Wothers, Seaford, DE (US)

Correspondence Address: KEITH R. LANGE, 103 FORESTVILLE ROAD, LINCOLN UNIVERSITY, PA, 19352, US

(21) Appl. No.: 11/682,417

(22) Filed: Mar. 6, 2007

Related U.S. Application Data
(60) Provisional application No. 60/778,972, filed on Mar. 6, 2006.

(51) Int. Cl. F21V 33/00; B65D 1/36

(52) U.S. Cl. 220/506; 362/101

(57) ABSTRACT

The present invention relates to a shot glass having a handle. In some embodiments, a shot glass having a handle is provided so that the shot glass can be lowered into a drinking vessel having a larger volume than the shot glass. In still other embodiments, a shot glass with a handle having an attachment piece which is capable of removably connecting the handle of the shot glass to the rim (or other portion) of a larger drinking vessel. In yet additional embodiments, a shot glass having a handle as well as a novelty lighting and/or sound emitting mechanism (e.g., which, in some embodiments, includes a pressure or moisture activated contact switch).

### RELATED APPLICATIONS

This application claims priority to U.S. Provisional Patent Application No. 60/778,972, filed on Mar. 6, 2006, which is hereby incorporated by reference in its entirety.

### FIELD OF THE INVENTION

The present invention relates to a shot glass having a handle. In some embodiments, this invention relates to a shot glass having a handle provided so that the shot glass can be lowered into a drinking vessel having a larger volume than the shot glass. In still other embodiments, this invention relates to a shot glass with a handle having an attachment piece which is capable of removably connecting the handle of the shot glass to the rim (or other portion) of a larger drinking vessel. In yet additional embodiments, this invention relates to a method of pre-preparing and/or serving drinks in which a shot glass is attached to a wall of a larger glass.

### BACKGROUND OF THE INVENTION

Shot glasses are traditionally small vessels, in the shape of miniaturized drinking glasses which are used to serve small volumes, typically between 1.0 and 1.5 oz., of liquor, termed “shots”. Although the use of shot glasses has conventionally involved either the sipping or “shooting” (“shooting” being defined as ingesting the contents of the shot glass in a single act or swallow) of single (i.e., non-mixed) liquors, during recent decades, the types of drinks served in shot glasses, as well as the methods of ingesting them, have multiplied and evolved significantly. For example, there are now countless numbers of mixed alcoholic concoctions which are served as shots (some widely known, others being proprietary to a single bartender or bar).

Moreover, now, rather than simply “shooting” the contents of shot glasses, methods of mixing the contents of shot glasses with those of larger volume drinking vessels have become widespread and popular. In such an example method, a shot glass is filled with one type of alcohol, or mixture thereof, and a larger glass (e.g., such as a pilsner glass) is filled (typically, in-part) with either an alcoholic or non-alcoholic drink. Thereafter, the shot glass is dropped into the larger glass by which the contents of the shot glass and the larger glass mix (and are more thoroughly mixed when the larger glass is tilted for ingestion). Older drink-types which employ such mixing methods are known as Boilermakers, Sake-Bombers and Irish Car Bombs with the most contemporary variant being known as a Jager-Bomb.

Although employing a conventional shot glass in preparing and serving such drink types is crudely useful to achieve the general mixing effect, dropping a conventional shot glass into a larger glass (e.g., a pilsner glass or beer mug) has several drawbacks. For example, a typical shot glass has considerable mass and splashes the larger glassware's contents when dropped therein. Furthermore, after the shot glass has been dropped into the larger glass, when the mixed drink is tilted for ingestion, it is not uncommon for the shot glass to slide or move within the larger glass due to gravity. Because the shifting or movement of the shot glass is often sudden and/or unexpected, the shot glass will sometimes hit the mouth of the person drinking the beverage, potentially causing spillage and/or inflicting injury to the person's mouth and/or teeth. Moreover, when the person drinking the beverage “rights” the larger vessel to a vertical position (sometimes quickly or suddenly in reaction to the falling or sliding shot glass), the shot glass falls or slides in the reverse direction and impacts the bottom of the larger vessel with the potential of causing breakage to one or the other (or both).

As an additional drawback in the art, despite their widespread popularity, certain drink types such as Jager Bombs, due to their manner of being made, cannot be sold to bar patrons in the same high volume manner by mobile tray shot servers as many other shot types. For example, certain popular shot types are carried around on trays by mobile servers that walk amongst bar crowds. Employing such sales tactics, often utilizing various gimmicks such as serving the shots in test tubes or gelatinizing the alcohol as so called JELLO-shots, bars can significantly improve their gross alcohol sales by, in part, reducing the need for patrons to visit the physical bar area. However, due to the unique mixing methods of the drink types mentioned above in which the actual dropping of the shot into the larger glass is viewed as part of the overall drink experience, the ability and/or desirability of serving drinks, such as Jager Bombs, by mobile shot servers is very limited (due to the need for carrying both conventionally sized drink vessels and shot glasses on a single tray, i.e., a pair of each compromising a single drink). Specifically, because the above-described drink types employ two separate glasses, the volume of such drink types which can be carried on a tray is reduced by approximately one-third to one half as compared to single glass drink types. Moreover, separately handling two glasses per drink sold is time consuming and can be physically awkward in a crowded bar environment.

In view of the above-enumerated drawbacks, it is apparent that there exists a need in the art for apparatus and/or methods which overcome such drawbacks. It is a purpose of this invention to fulfill these needs in the art, as well as other needs which will become apparent to the skilled artisan once given the above disclosure.

### SUMMARY OF THE INVENTION

The present invention relates to a shot glass having a handle. In some embodiments, this invention relates to a shot glass having a handle provided so that the shot glass can be lowered into a drinking vessel having a larger volume than the shot glass. In still other embodiments, this invention relates to a shot glass with a handle having an attachment piece which is capable of removably connecting the handle of the shot glass to the rim (or other portion) of a larger drinking vessel. In yet additional embodiments, this invention relates to a method of pre-preparing and/or serving drinks in which a shot glass is attached to a wall of a larger glass.

In one aspect, the present invention relates to a shot glass having (a) a bottom surface; (b) a side wall extending upwardly from the bottom surface, wherein the bottom surface and the side wall define a vessel for holding a liquid, the vessel having a closed first end and an open second end; and (c) a handle associated with the side wall. The side wall may be continuous, and may be substantially circumferential in shape. The handle may be integral with the side wall, may be fixedly attached to an outer surface of the side wall, may be fixedly attached to an inner surface of the side wall, may be removably attached to an outer surface of the side wall, or may be removably attached to an inner surface of the side wall.

The shot glass may further have a ring or sleeve which may be fixedly or removably attached to the handle, wherein the side wall is capable of contacting the ring or sleeve in order to suspend the bottom surface and the side walls from the ring or sleeve. The shot glass may further have a lighting mechanism, which may include one or more light emitting diodes (LEDs), which may be activated by pressure. Further, each of the side wall, bottom surface and handle may independently be made of a polymer (which may be plastic), glass and metal.

Moreover, the side wall may be tapered such that the circumference of the open second end is greater than the circumference of the closed first end. The handle may have a non-linear portion, which may be substantially curved, which permits the shot glass to suspend from a container, which may be a drinking glass, such as a beer mug.

In another aspect, the present invention is directed to a shot glass, having (a) a bottom surface; (b) a side wall extending upwardly from the bottom surface, wherein the bottom surface and the side wall define a vessel for holding a liquid, the vessel having a closed first end and an open second end; (c) a handle associated with the side wall; and (d) a lighting mechanism, which may include LEDs associated with the bottom surface.

In another aspect, the present invention relates to a shot glass, having (a) a bottom surface; (b) a side wall extending upwardly from the bottom surface, wherein the bottom surface and the side wall define a vessel for holding a liquid, the vessel having a closed first end and an open second end; (c) a handle; and (d) a ring or sleeve attached to the handle, wherein the side wall is capable of contacting the ring or sleeve in order to suspend the bottom surface and the side walls from the ring or sleeve.

In another aspect, the present invention relates to a shot glass, having (a) a bottom surface; (b) a side wall extending upwardly from the bottom surface, wherein the bottom surface and the side wall define a vessel for holding a liquid, the vessel having a closed first end and an open second end; (c) a handle; (d) a ring or sleeve attached to the handle, wherein the side wall is capable of contacting the ring or sleeve in order to suspend the bottom surface and the side walls from the ring or sleeve; and (e) a lighting mechanism associated with the bottom surface.

In another aspect, the present invention relates to a drinking glass assembly, having (a) a shot glass, the shot glass having (i) a bottom surface; (ii) a side wall extending upwardly from the bottom surface, wherein the bottom surface and the side wall define a vessel for holding a liquid, the vessel having a closed first end and an open second end; and (iii) a handle associated with the side wall; and (b) a drinking glass, wherein the shot glass is capable of being suspended from the drinking glass. The drinking glass assembly may have a lighting mechanism, which may include LEDs.

### BRIEF DESCRIPTION OF THE DRAWINGS

FIG. 1A illustrates a three-dimensional view of one embodiment of a shot glass according to the present invention.

FIG. 1B illustrates a three-dimensional view of an alternative embodiment of a shot glass according to the present invention.

FIG. 1C illustrates a three-dimensional view of an additional alternative embodiment of a shot glass according to the present invention.

FIG. 1D illustrates the embodiment of the shot glass depicted in FIG. 1B shown illustrated installed on a large volume drinking vessel.

FIG. 1E illustrates the embodiment of the shot glass depicted in FIG. 1C having a lighting mechanism.

FIG. 2 illustrates a three-dimensional, detailed view of the shot glass handle attachment mechanism illustrated in FIG. 1A.

FIG. 3 illustrates a cross-sectional, detailed view of the shot glass handle attachment mechanism illustrated in FIG. 1A shown installed on a glass rim having a lip portion.

FIG. 4 illustrates a method of serving pre-prepared drinks, in volume, utilizing the embodiment of the shot glass illustrated in FIG. 1A according to one embodiment of the present invention.

FIG. 5 illustrates a cross-sectional view of a adaptor handle according to one embodiment of the present invention.

FIG. 6 illustrates a cross-sectional view of the adapter handle depicted in FIG. 5 installed on a rim of a shot glass.

### DETAILED DESCRIPTION OF CERTAIN EMBODIMENTS

For a more complete understanding of the present invention and advantages thereof, reference is now made to the following description of various illustrative and non-limiting embodiments thereof, taking in conjunction with the accompanying drawings in which like reference numbers indicate like features.

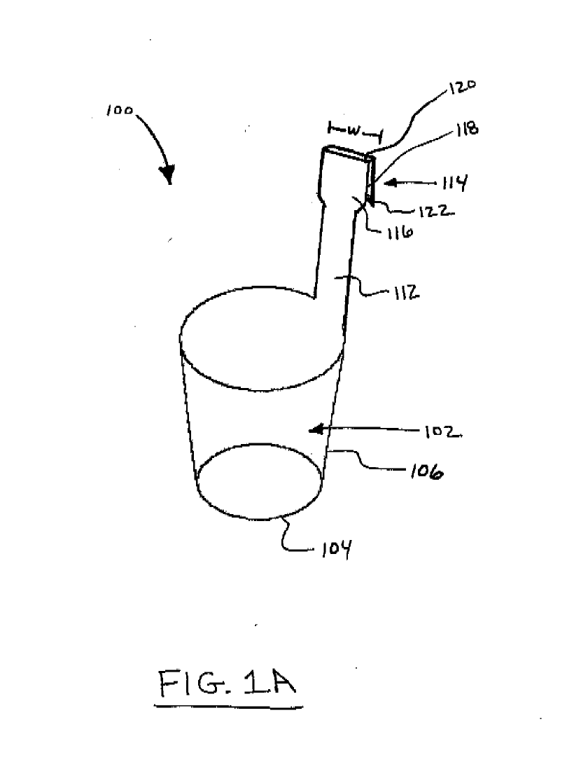

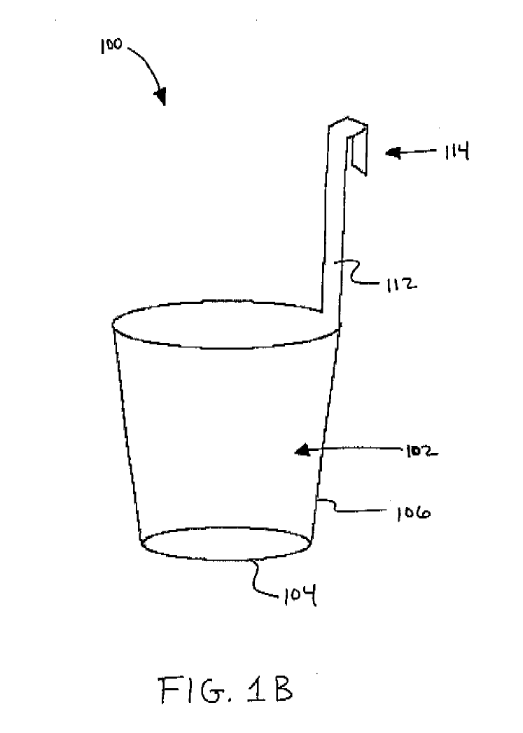

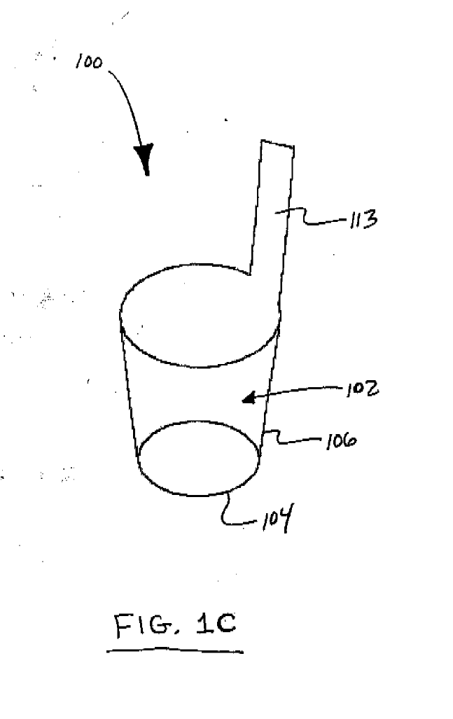

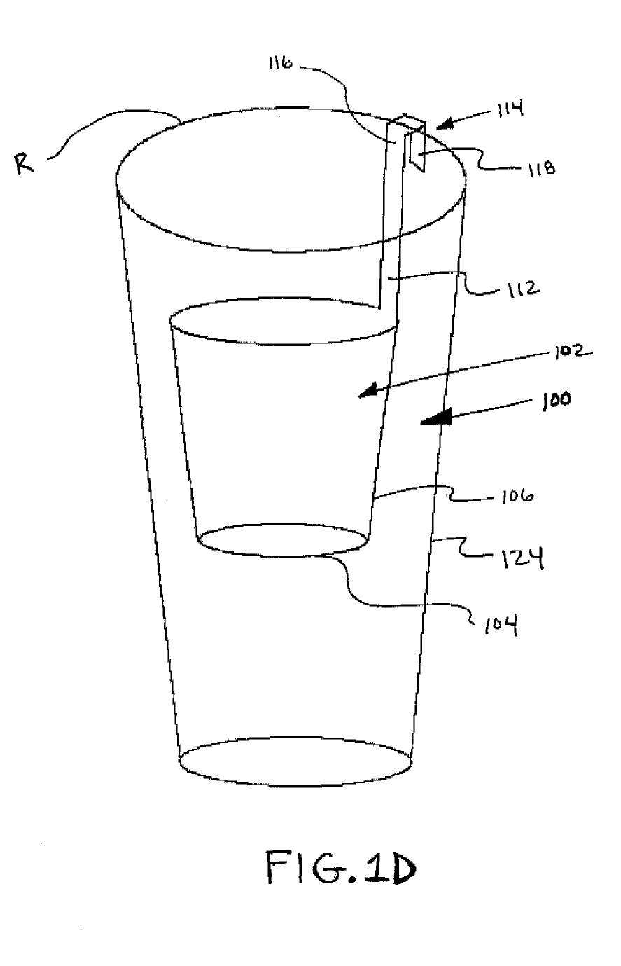

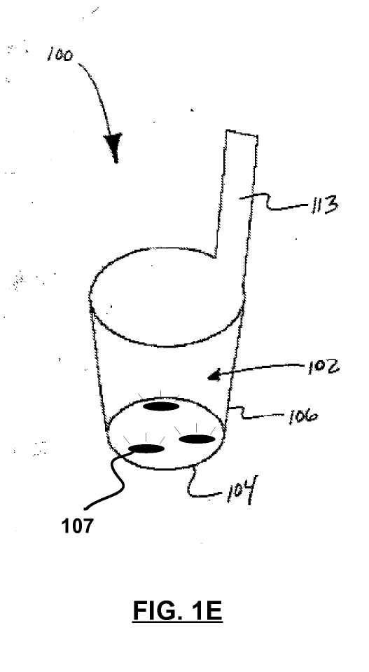

Generally speaking, and with reference initially to FIGS. 1A, 1B and 1C, the present invention, as illustrated, relates to a shot glass 100 having a handle (e.g, 112 in FIG. 1A, or 113 in FIG. 1C) which can be used to lower the shot glass in a controlled manner into a larger volume glass and additionally or alternatively, which can be attached to the rim of a larger glass via an attachment piece on the handle. The shot glass may be made of any suitable material for its intended purpose, for example, glass, polymers (such as plastic) or metal.

Turning now to FIG. 1A, in this regard, an embodiment of shot glass 100 having a handle designed to connect to a wall or rim of a larger volume drinking vessel (see vessel 124 in FIG. 1D) is disclosed therein. As illustrated, shot glass 100 is generally comprised of a circumferential wall 106 connected to a bottom 104 which defines a liquid container portion 102. Although shot glass 100, as illustrated, is generally cylindrical in shape with a diminishing diameter or taper progressing from its top (i.e., the open mouth of the glass) to its bottom 104, other configurations which are non-tapered and/or non cylindrical are, of course, contemplated.

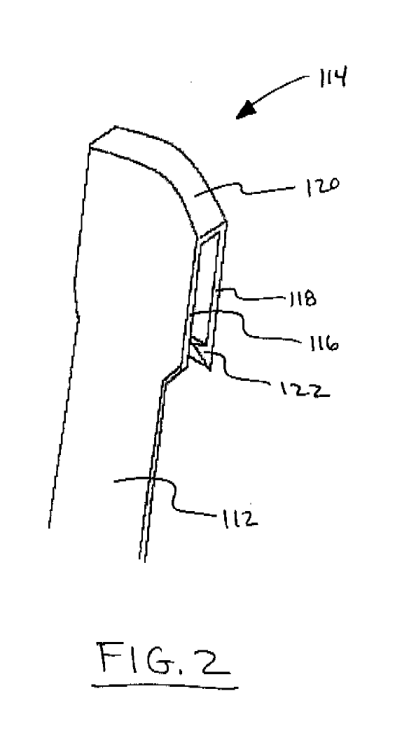

As can be seen in FIG. 1A, handle 112 is attached to and extends upwardly from container portion 102 and includes an attachment piece 114 at one end thereof. Although various structural configurations of attachment piece 114 may be used in practicing the subject invention, a specific configuration, illustrated in FIG. 1A and in more detail in FIG. 2, has proven particularly efficacious in both functionality and ease and expense of manufacture. Specifically, as illustrated in such figures, attachment piece 114 comprises a first vertical planar portion 116 extending upwardly from the end of handle 112, a second vertical planar portion 118 extending downwardly and generally parallel to planar portion 116, and a horizontal portion 120 extending between and connecting portions 116 and 118 one to the other. Moreover, in this embodiment, a catch 122 is formed in a distal end of portion 118 which aids in locking the attachment piece 114 and, therefore, the shot glass to the rim or wall of a glass, as is described below.

In certain preferred example embodiments such as are illustrated, either of, but preferably both, of portions 116 and 118 have a width “W” (see FIG. 1A) which is selected to be of sufficient dimension such that lateral twisting of attachment piece 114 (and thus of handle 112 and container 102) relative to rim “R” of glass 124 (see FIG. 1D) is minimized. Furthermore, in such embodiments, portions 116, 118, and 120 are preferably curvilinear in shape (see FIG. 2) so that their configuration generally mirrors the curvature of typical glassware. Specifically, by utilizing sufficient widths “W” in combination with such curvilinear configurations (with curvatures which generally mimic or follow those of a larger drinking vessel), contact between the relative surfaces of attachment piece 114 and a glass to which it attaches (e.g., at rim “R” of vessel 124 and along the vessel sidewalls in FIG. 1D) is maximized. This, in turn, results in a secure connection of the shot glass to a larger vessel, such as 124 (e.g., a non-loose connection in which undesired movement of the shot glass, relative to the larger vessel when attached, is minimized).

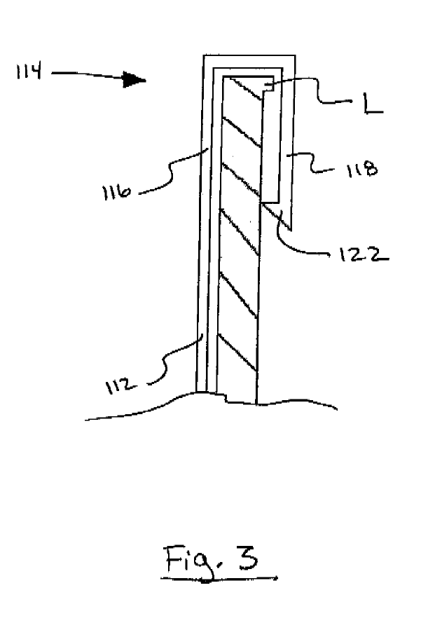

Further serving this purpose, catch 122, in some embodiments (see FIGS. 1A, 2 and 3), either through frictional contact, interfering or obstructional contact (e.g., with a lip “L” of a glass rim; see FIG. 3), or some combination thereof; serves to secure attachment piece 114 to the larger vessel rim “R” and/or vessel walls. In particularly preferred embodiments, the attachment is secure enough such that shot glass 100 remains attached to vessel 124 even when vessel 124 is inverted, for example. In particular, such attachment solves or ameliorates the above-described problems related to a sliding or falling shot glass during a drink “shooting” process (e.g., while drinking a “Jager Bomb”).

Although the specific handle and attachment piece illustrated in FIGS. 1A, 2 and 3 is a preferred configuration, alternative handle and attachment structures, such as those illustrated in FIG. 1B (e.g., without catch 122), are likewise contemplated as within the scope of the invention.

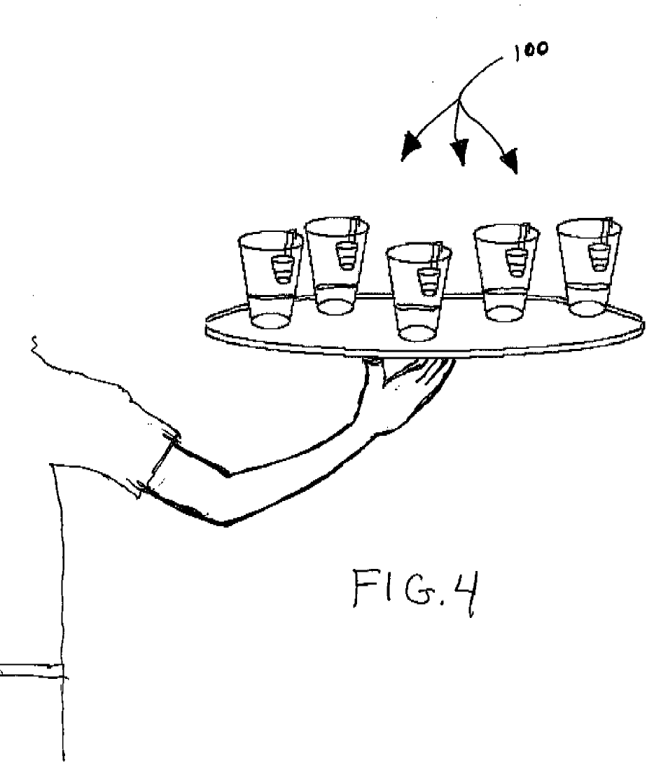

As a further advantage to shot glass 100 as it is illustrated, for example, in FIGS. 1A and 1B, the aforementioned problem of serving drinks, such as Jager Bombs, by mobile shot servers is at least partially solved therewith. In this regard, and referring now to FIG. 4, a tray of drinks employing shot glass 100 may be pre-prepared and carried through and around bar patrons for sale thereof. For example, by sizing the length of handle 112 so that shot glass 100 is not submerged in the volume of alcohol in the larger vessel, an entire tray of Jager Bombs, for example, each with shot glass 100 suspended above the fluid in the larger glass, may be prepared and carried utilizing substantially less tray space than if conventional shot glasses were used (because such conventional shot glasses take up space on the tray which could otherwise be used for an additional large vessel). Once such a prepared drink is served to a patron, the purchaser can thereafter remove the shot glass from its attachment to the larger vessel's side wall or rim, and then drop the shot glass into the fluid of the larger glass for consumption.

Other methods and mechanisms of pre-preparing such drink types including simply reducing the amount of fluid in the larger glass rather than pre-selecting a handle length, or, attaching shot glass 100 so that it hangs on the outside of the larger drinking vessel (so that the fluids in the shot glass and the larger glass do not mix until intended) are, of course, contemplated.

Referring now to FIG. 1C, an embodiment of shot glass 100 which employs a handle 113 without an attachment piece 114 (for connecting to a separate, larger drinking vessel) is depicted therein. In this regard, it may be desirable, in certain circumstances, to employ a shot glass 100 that is not attachable to a larger drinking vessel but which still provides the ability to lower the shot glass into the larger glass with control so as to avoid the aforementioned problems pertaining to splashes or spills. Permitting such functionality, the embodiment of shot glass 100 illustrated in FIG. 1C includes a handle 113 which extends linearly upwardly from wall 106 and which has a generally planar portion with a width which is easily grasped for holding and lowering the shot glass into a larger vessel (such as 124 in FIG. 1D). Moreover, handle 113 can be utilized to remove the shot glass from a larger vessel without requiring that the glass be inverted, for example (thus preventing or eliminating spillage).

Shot glass 100 may further include certain novelty elements, including a lighting mechanism 107 (FIG. 1E) or sound emitting mechanism. Lighting mechanism 107 may include, for example, one or more light emitting diodes (LEDs) which emit light of the same or various colors that will reflect through the liquid in liquid container portion 102. In certain embodiments, lighting mechanism 107 is activated by a pressure or moisture contact switch.

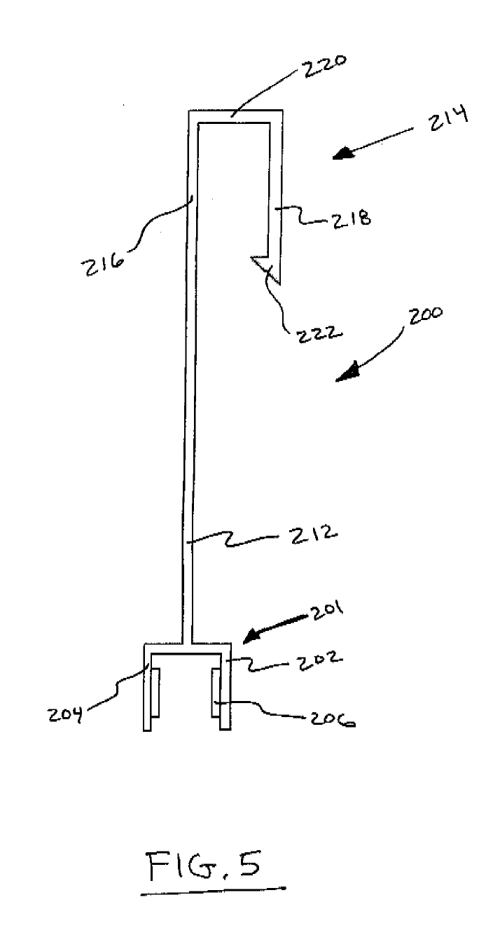

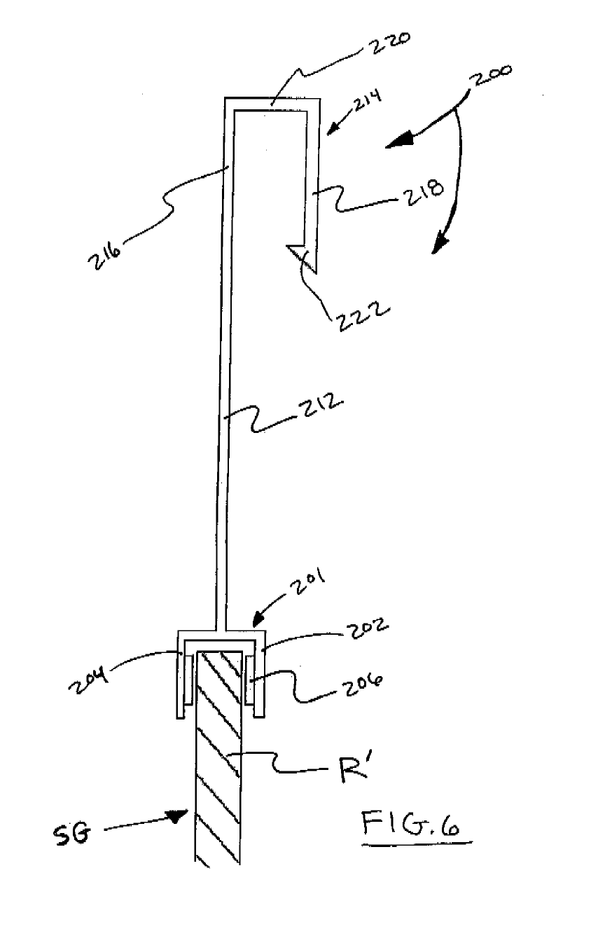

Referring now to FIGS. 5 and 6, an embodiment of an adaptor handle 200 which is capable of attaching to a conventional shot glass rim “R” or wall for converting such a conventional shot glass to have the functionality of shot glass 100 is disclosed therein. Specifically, adaptor handle 200 includes various parts which correspond generally to analogous parts of shot glass 100 including a handle 212, an attachment piece 214 (comprised of walls 216, 218, 220 and catch 222) but further includes a clip 201 which is capable of securely attaching the handle to a typical shot glass “SG”. In particular, in this example embodiment, clip 201 include two opposing generally vertical walls 202 and 204 (curvilinear in configuration in certain embodiments) which are spaced such that they are capable of gripping the rim “R” (or wall) of shot glass “SG”.

Moreover, in certain preferred embodiments such as illustrated, clip 201 further includes frictional or adhesive pads 206 (e.g., comprised of rubber or some other gripping or non-slip type material) which aid in gripping or adhering to the rim or side walls of the shot glass.

Once given the above disclosure, many other features, modifications, and improvements will become apparent to the skilled artisan. Such other features, modifications, and improvements are therefore considered to be part of this invention, the scope of which is to be determined by the following claims:

What is claimed is:

1. A shot glass, comprising:
a. a bottom surface;
b. a side wall extending upwardly from said bottom surface, wherein said bottom surface and said side wall define a vessel for holding a liquid, said vessel having a closed first end and an open second end; and
c. a handle associated with said side wall.

2. A shot glass of claim 1, wherein said side wall is continuous.

3. A shot glass of claim 1, wherein said side wall is substantially circumferential in shape.

4. A shot glass of claim 1, wherein said handle is integral with said side wall, is fixedly attached to an outer surface of said side wall, is fixedly attached to an inner surface of said side wall, is removably attached to an outer surface of said side wall, or is removably attached to an inner surface of said side wall.

5. A shot glass of claim 1, further comprising a ring or sleeve attached to said handle, wherein said side wall is capable of contacting said ring or sleeve in order to suspend said bottom surface and said side walls from said ring or sleeve.

6. A shot glass of claim 5, wherein said ring or sleeve is fixedly or removably attached to said handle.

7. A shot glass of claim 1, further comprising a lighting mechanism.

8. A shot glass of claim 7, wherein said lighting mechanism comprises one or more light emitting diodes (LEDs).

9. A shot glass of claim 8, wherein said LEDs are activated by pressure.

10. A shot glass of claim 1, wherein said side wall, said bottom surface and said handle are each independently made of a material selected from the group consisting of one or more polymers, glass and metal.

11. A shot glass of claim 10, wherein said one or more polymers is a plastic.

12. A shot glass of claim 1, wherein said side wall is tapered such that the circumference of said open second end is greater than the circumference of said closed first end.

13. A shot glass of claim 1, wherein said handle has a non-linear portion thereof which permits said shot glass to suspend from a container.

14. A shot glass of claim 13, wherein said non-linear portion thereof is substantially curved.

15. A shot glass of claim 13, wherein said container is a drinking glass.

16. A shot glass of claim 15, wherein said drinking glass is a beer mug.

17. A shot glass, comprising:
a. a bottom surface;
b. a side wall extending upwardly from said bottom surface, wherein said bottom surface and said side wall define a vessel for holding a liquid, said vessel having a closed first end and an open second end;
c. a handle associated with said side wall; and
d. a lighting mechanism associated with said bottom surface.

18. A shot glass of claim 17, wherein said lighting mechanism includes LEDs.

19. A shot glass, comprising:
a. a bottom surface;
b. a side wall extending upwardly from said bottom surface, wherein said bottom surface and said side wall define a vessel for holding a liquid, said vessel having a closed first end and an open second end;
c. a handle; and
d. a ring or sleeve attached to said handle, wherein said side wall is capable of contacting said ring or sleeve in order to suspend said bottom surface and said side walls from said ring or sleeve.

20. A shot glass, comprising:
a. a bottom surface;
b. a side wall extending upwardly from said bottom surface, wherein said bottom surface and said side wall define a vessel for holding a liquid, said vessel having a closed first end and an open second end;
c. a handle;
d. a ring or sleeve attached to said handle, wherein said side wall is capable of contacting said ring or sleeve in order to suspend said bottom surface and said side walls from said ring or sleeve; and
e. a lighting mechanism associated with said bottom surface.

21. A drinking glass assembly, comprising:
a. a shot glass, said shot glass comprising:
i. a bottom surface;
ii. a side wall extending upwardly from said bottom surface, wherein said bottom surface and said side wall define a vessel for holding a liquid, said vessel having a closed first end and an open second end; and
iii. a handle associated with said side wall; and
b. a drinking glass, wherein said shot glass is capable of being suspended from said drinking glass.

22. A drinking glass assembly of claim 21, further comprising a lighting mechanism.

23. A drinking glass assembly of claim 22, wherein said lighting mechanism includes LEDs.
